(19) United States
(12) Patent Application Publication
(10) Pub. No.: US 2011/0057120 A1
(43) Pub. Date: Mar. 10, 2011

(54) Apparatus for determining the element occupancy on a surface by means of fluorescence

(75) Inventors: Heinrich Ostendarp, Haan (DE); Siegfried Piontek, Wuppertal (DE)

(73) Assignee: Bohle AG, Haan (DE)

(21) Appl. No.: 12/593,092

(22) PCT Filed: Jun. 5, 2009
(86) PCT No.: PCT/EP2009/056926

§ 371 Date: Sep. 25, 2009

(30) Foreign Application Priority Data
Jun. 5, 2008 (DE) 20 2008 007542.4
Jun. 5, 2008 (EP) 08104278.0

(51) Int. Cl. G01N 21/64; G01N 21/958

(52) U.S. Cl. 250/461.1

(57) ABSTRACT

An apparatus for determining element occupancy on a surface includes a UV beam source comprising at least one UV light-emitting diode whose UV radiation excites the element to fluorescence and a detector unit for the detection of fluorescence radiation. The apparatus, in accordance with the invention, is characterized in that beam guidance is configured by alignment of the UV beam source and the detector unit relative to the surface and/or by using a wavelength-selective beam splitter in the beam path in such a manner that the UV radiation back-reflected from the surface is kept away from the detector unit.

### CROSS-REFERENCE TO RELATED APPLICATIONS

This application is a National Phase Application of International Application No. PCT/EP2009/056926, filed on Jun. 5, 2009, which claims the benefit of and priority to German patent application no. DE 20 2008 007 542.4, filed on Jun. 5, 2008 and European patent application no. EP 08 104 278.0, filed on Jun. 5, 2008. The disclosures of the above applications are incorporated herein by reference in their entirety.

### FIELD OF THE INVENTION

The invention relates to an apparatus for determining the element occupancy on a surface, in particular for determining the tin contamination on float glass, comprising a UV beam source comprising at least one UV light-emitting diode whose UV radiation excites the element to fluorescence, and comprising a detector unit (2) for detecting the fluorescence radiation.

### BACKGROUND

In modern glass manufacture, plate glass which is used, for example, as window glass but also as a primary product for mirror and automobile glass is manufactured predominantly (about 95%) as float glass in the float process. In this process, the purified doughy-liquid glass melt at 1100° C. is passed progressively from one side in a continuous process into an elongate bath of liquid tin which is held in a protective gas atmosphere to avoid oxidation. On the surface of the liquid tin the approximately two thirds lighter glass floats and spreads out uniformly like an oil film. Extremely smooth surfaces are formed due to the surface tension of the tin and the liquid glass. The solidified still-warm glass at about 600° C. at the cooler end of the bath is progressively extracted and passed through a cooling furnace in which it is cooled down in a stress-free manner. Following an optical quality control, the glass is finally cut.

The particular properties of tin make it particularly suitable for use in float glass manufacture. For example, tin has a comparatively low melting point of 232° C. so that it still remains liquid until the glass has completely solidified; furthermore, at the 1100° C. used it does not have a high vapor pressure which could lead to deposits and unevenesses on the underside of the glass and it behaves in an inert manner with respect to the glass. However, there is some slight diffusion-induced absorption of Sn²⁺ ions in the surface of the float glass on the tin bath side which constitutes a problem when a particular surface purity is required. This is required, for example, when glass surfaces are functionalized to produce glass bonds, for glass adhesion or for coating.

A further appreciable problem is so-called glass corrosion which occurs both on the tin bath side and also on the side facing away from the bath. However, a protective coating can be applied more reliably on the side facing away from the bath.

Glass corrosion in detail comprises a structural variation and associated weathering of the glass surface due to various chemical and physical influences which, as corrosion progresses, becomes macroscopically noticeable due to misting as a result of a thin roughening and fine crack formation in the surface. Microscopically, corrosion begins with the dissolving out of oxides of various elements, e.g. sodium, potassium, calcium, barium or boron. The physical properties of the material therefore vary at the affected locations. A gel layer is formed which further reacts with ions of the acting substance to form an opaque coating which also noticeably adversely affects the transparency of the surface and therefore the impression of quality.

Glass corrosion has a number of further serious disadvantages. For example, when glass panes are handled in the warehouse by means of suckers, imprints of the suckers can form on the gel layer of the glass pane surfaces. Furthermore, during storage of the glass panes the gel layer is strengthened by air moisture and condensation of water on the surfaces of the glass in such a manner that adjacent panes can even stick to one another in stacks of panes. Another problem of glass corrosion is that it can lead to defects or deficient qualities in coatings or finishings on the gel layer or corroded layer.

The tin bath side and the side facing away from the tin bath in float glass production therefore exhibit a number of appreciable differences which can be of considerable importance during the further processing of the glasses. It is therefore of crucial importance to be able to reliably determine the tin bath side of the glass product at any point in time.

In this case, use can be made of the fact that the tin atoms diffusing on the tin bath side of the glass are excited to fluorescence by UV light. In the case of fluorescence, the atoms are each excited by absorption of a light quantum, in the present case a UV light quantum, into an electronically excited state which, as a result of the short lifetime of this state (a few nanoseconds) almost instantaneously initiates a relaxation process which proceeds on the one hand in an emission-less manner by conversion into oscillation energy or in an emitting manner by emission of a fluorescence photon. According to Stokes law, the fluorescence quantum has a lower energy and therefore a longer wavelength so that in the case of tin atoms, it pertains to the visible part of the electromagnetic spectrum. A typical fluorescence spectrum is shown in FIG. 4. A strongly broadened fluorescence peak between about 360 nm and about 750 nm having a maximum at about 500 nm is clearly visible, which has some superposed characteristic lines. A milky bluish-grey fluorescence light can be detected macroscopically as the overall impression.

As a result of the short absorption length of the UV radiation in glass, only the directly illuminated tin atoms are excited which means that the tin bath side can be unambiguously identified since the UV light is absorbed on the surface when the atmosphere side is irradiated so that tin atoms present on the rear surface of the glass product are no longer excited and accordingly no fluorescence can be detected. It is therefore possible to distinguish the tin bath side of the float glass from the side or sides not coming in contact with the tin bath by means of an optical testing method.

In order to determine the tin bath side of the glass product, it is known from practice to irradiate its surface with a mercury low-pressure vapor lamp as is known, for example, from bank note testing equipment. However, this involves an extremely coarse and inaccurate measurement method since the fluorescence intensity is very low relative to the intensity of the Hg lamp and is strongly superposed by this. Thus, this comprises an apparatus which can only be handled with difficulty, which additionally does not yield any quantifiable fluorescence measurement result but merely makes the effect of the fluorescence visible on the glass surface.

### SUMMARY OF THE INVENTION

Starting from this, it is an aspect of the invention to provide an apparatus of the type specified in the Field of the Invention, which makes it possible to achieve a rapid, reliable determination of the element occupancy of a surface and is at the same time easy to operate. Furthermore, the apparatus should be characterized by comparatively low purchase and operating costs and the components used should have a long lifetime.

The aspect is achieved with an apparatus comprising a UV beam source including at least one UV light-emitting diode whose UV radiation excites the element and fluorescence and a detector unit for the detection of fluorescence radiation, whereby the beam guidance is configured by alignment of the UV beam source and the detector unit relative to the surface and/or by using a wavelength-selective beam splitter in the beam path in such a manner that the UV radiation back-reflected from the surface is kept away from the detector unit.

The apparatus according to the invention can be used to determine all the elements on a surface which can be exited in the UV range of the electromagnetic spectrum and which emit excitation energy by means of fluorescence. Accordingly, a wide spectrum of possible applications in materials testing is possible. In particular, it is suitable for determining the tin contamination on float glass. However, the apparatus according to the invention can also be used for checking banknotes, stamps or other security labels or tags at airports or other security-relevant areas.

The particular advantage of the apparatus according to the invention is that as a result of the compact dimensions of a UV LED compared to conventional Hg vapor lamps and as a result of the robustness and longevity inherent in an LED, this can easily be designed as a mobile portable measuring instrument as well as a stationary measuring instrument in a production line. The comparatively low power consumption of an LED combined with a far less expensive triggering electronics—ballasts and starters are not necessary—make a UV LED additionally suitable for building into a compact autonomous and easy-to-operate portable instrument. By using a detection unit, the fluorescence on the surface can be detected reliably and display purely qualitatively or also quantitatively depending on any optional downstream evaluation electronics. In order to maximize the quantum yield in the fluorescence, particularly of tin, a light-emitting diode emitting in the UV-C range of the electromagnetic spectrum (100 nm-280 nm, corresponding to 12.4-4.43 eV) is preferably used, the emission maximum preferably lying at 280 nm.

By aligning the beam source and the detector unit relative to the surface to be studied, in a configuration in which the beam source and the detector unit are disposed on the same side of the surface, in which case they can easily be located in a common housing in a space-saving manner, it can easily be achieved that the measurement result for the fluorescence radiation does not undergo any interference due to the UV radiation back-reflected from the surface acting upon the detector unit. In particular, it is not necessary here to bring about absorption of the back-reflected UV radiation in the beam path by using corresponding optical elements such as UV filters or similar, to keep this radiation away from the detector unit.

This relative alignment of UV beam source and detector unit is preferably simply achieved by aligning the detector unit outside the reflected beam. If the surface to be studied, for example, comprises a float glass surface, the irradiated UV light is back-reflected at a defined reflection angle as a result of the very smooth glass surface so that an alignment of the detector unit outside the reflected beam is easily possible.

According to a further advantageous embodiment of the invention, it is provided for this purpose that the at least one UV light-emitting diode irradiates the surface at an angle of incidence α>0 and the detector unit is aligned substantially perpendicularly to the surface. In this case, it is advantageously taken into account that the intensity of the fluorescence radiation usually has an intensity maximum in the perpendicular direction relative to the surface so that a signal of comparatively high intensity can be measured in the detector unit.

In addition to the aforesaid configuration, it is alternatively possible that the at least one UV light-emitting diode irradiates the surface at a vanishing angle of incidence (α=0) and the detector unit is aligned in such a manner that it detects the fluorescence radiation emitted at an angle to the surface. In this case, the UV radiation of the UV light-emitting diode is back-reflected into this again and cannot therefore be incident on the detector unit which for its part accordingly only measures the fluorescent radiation. If the light emitted by the UV light-emitting diode is divergent, it is understood that the detector unit is aligned in such a manner that it is disposed outside the light cone.

Both the variants described previously have the advantage that they are particularly suitable for portable measuring instruments as a result of their simple structure. The comparatively strong distance sensitivity of these configurations can be countered by integrating the measurement arrangement in a housing that is placed on the surface to be studied so that the surface-to-detector unit distance is always defined.

Alternatively or additionally, the beam guidance of the apparatus according to the invention comprises a wavelength-selective beam splitter in the beam path of the measurement structure. This can be provided, for example, with a wavelength-selective surface coating which largely reflects the UV radiation of the beam source whilst the fluorescence light is largely transmitted. Likewise, the coating can be designed in such a manner that the UV radiation of the beam source is transmitted whilst the fluorescence light is reflected.

In the case of a coating which reflects the UV radiation, the beam guidance of the apparatus can, for example, be configured in such a manner that the UV radiation emitted by the at least one light-emitting diode is reflected onto the surface to be studied, i.e. is deflected and the fluorescence radiation is passed through the beam splitter which is transparent to this radiation, onto the detector unit. If beam source and beam splitter are aligned in such a manner that the UV radiation deflected by the beam splitter onto the surface is incident on the surface at a non-vanishing angle of incidence, i.e. obliquely, with a suitably selected angle the back-reflected radiation is no longer incident on the beam splitter and thus on the detector unit.

It is important for the easy handling of the apparatus to allow the user of the apparatus the greatest possible freedom in the choice of measurement distance. This is preferably achieved by the radiation source having at least one first beam-forming element, wherein the beam-forming element collimates the beam. In this case, an approximately parallel bundle of rays is produced which makes it possible to achieve a uniform excitation intensity on the surface to be studied regardless of the distance selected in each case. Screens and/or collimator lenses can be used for adequate beam forming.

The detector unit for its part preferably comprises a detector element for converting the radiation into an electrical signal. The detector unit can, for example, be configured as a photodiode whose return current varies depending on the incident fluorescence radiation. In order to maximize the measurable fluorescence intensity and therefore in order to maximize the signal-noise ratio in the measurement signal, the detector unit is furthermore preferably provided with a beam-forming element for focussing the fluorescence radiation onto the detector element. This beam-forming element is expediently configured as at least one focussing lens. In addition, as much interfering light as possible should be kept away from the detector element, which is possible by using corresponding filters for attenuating spectral ranges not of interest (for example, the near infrared). Another advantage of using focussing optics is that the distance sensitivity of the measurement signal is severely reduced.

According to a further advantageous embodiment of the invention, the apparatus comprises means for online monitoring of the UV beam power of the at least one UV light-emitting diode. It is thereby ensured that oscillations in the intensity of the fluorescence radiation which are attributable to an oscillation in the exciting UV beam power are identified as such. In this case, the fluorescence intensity will simply recreate the oscillation pattern of the emitted UV intensity and can thus be compensated by measurement electronics.

In detail, the means for online monitoring of the UV beam power, for example, can comprise a second fluorescent surface and second detector unit, wherein the second detector unit detects the fluorescence radiation emitted by the second surface. In this configuration, a small portion of the intensity emitted by the at least one UV light-emitting diode can be coupled out and directed onto the second fluorescent surface. The coupled-out beam intensity in turn brings about the emission of fluorescence radiation on the second surface which is then registered by the second detector unit. In this case, a second detector unit having the same design as the first detector unit connected to the same amplifier electronics coupled thereto can accordingly be used. By this means, for example, fluctuations of the electronic amplification, e.g. as a function of temperature, can be compensated.

If a wavelength-selective beam splitter is inserted in the beam path of the apparatus, this can be configured in such a manner that it reflects a large fraction (>>50%) of the power of the UV radiation onto the surface but transmits a small fraction. This can then advantageously be used for monitoring of the beam power without the UV beam power as a whole being significantly attenuated.

The means for online monitoring of the UV beam power can furthermore comprise a scattering and/or fluorescent surface disposed in the beam path of the UV radiation. This surface should be configured to be small relative to the beam cross-section of the beam emitted by the at least one UV light-emitting diode in order to minimise the associated attenuation of the beam power. For example, the scattering and/or fluorescent surface should account for no more than 10% of the beam cross-section. The particular advantage of such power coupling-out for online monitoring of the beam power is, inter alia, that in contrast to using a beam splitter, there is virtually no additional space requirement so that such an apparatus can be designed very compactly.

The surface itself can have various forms. It is particularly preferably configured as a thread disposed in the beam path of the UV radiation which consists of a material having the desired optical properties. For example, a polyamide or polyester fiber or a Polyneon® material coated with a fluorescent dye can be used as suitable fluorescent material. The diameter of the fibers is preferably 0.11 mm. Other surface geometries are also possible here. A crucial selection criterion in this case is that the beam properties of the UV light-emitting diode, in particular its beam divergence, are not significantly influenced by the surface located in the beam path in order to retain a defined irradiated surface on the surface to be studied.

In measurements of the fluorescence intensity, it is furthermore important to obtain convincing and reproducible results regardless of the illumination conditions of the surroundings. A measurement in the presence of UV radiation, for example, in the presence of solar irradiation must not falsify the measurement results. According to a further advantageous embodiment of the invention, it is therefore provided that the beam source comprises modulation means for modulating the UV radiation emitted by the light-emitting diode. It is hereby possible to, as it were, imprint an unmistakable pattern on the measurement radiation and therefore also on the fluorescence radiation, with the result that this can be distinguished compared with UV and visible light of the surroundings by corresponding evaluation means downstream of the detector unit.

In order to convert the intensity value of the fluorescence light incident on the detector element into a suitable signal, it is provided according to a further teaching of the invention that the apparatus comprises electronic evaluation means for producing an electrical signal value characterizing the fluorescence intensity. For example, it can be meaningful to convert the intensity value of the fluorescence value into a proportional direct voltage value which is expediently represented as a numerical value on a segment or matrix display in the display means downstream of the electronic evaluation means. If, in the production and further processing of glass products, in particular float glass, the apparatus according to the invention is used inline in a downstream production plant, the measured value can be processed directly in this production plant in order to supply the desired glass side to processing (e.g. adhesive bonding, coating, bond production etc.). When a glass side has been supplied for further processing, it is also possible to determine whether this processing is carried out on the desired side. In the production and processing of technical component surfaces in general, the apparatus can also be integrated in a production plant and the fluorescence values used as a measure for the element occupancy of the surface in order to ensure a uniform surface purity and therefore product quality. It is also possible to represent the detected fluorescence and therefore the identification of the side occupied by elements, or in the event of fluorescence not being detected, the identification of the non-occupied side, by means of a corresponding color display LED.

As studies made by the applicant have shown, the intensity of the fluorescence is also influenced by the material composition of the surface to be studied, in the case of a glass product to be studied by the material composition and within certain limits, by the glass manufacturing process. In order to minimize such influences which in isolated cases can make an unambiguous prediction about the orientation of the glass product impossible during the measurement, it is provided according to a further advantageous embodiment of the invention that a first threshold value can be set in the electronic evaluation means depending on the physical and/or chemical condition of the surface to be studied, below which threshold value the electrical signal value represents a surface not occupied by elements. The evaluation means are preferably configured in such a manner that they allow a simple input of a threshold value based, for example, on empirical values of the user directly before the measurement. Similarly, it can be provided that a second threshold value can be set in the electronic evaluation means depending on the physical and/or chemical condition of the surface to be studied, above which threshold value the electrical signal value represents a surface occupied by elements.

In another operating mode of the measuring device, a comparative measurement of both surfaces is carried out, in particular both glass surfaces, either by means of two sensors or successive measurements.

In the event of the excitation light emitted by the UV-LED used according to the invention being modulated, according to a further advantageous embodiment of the invention it is provided that the electronic evaluation means comprise at least one filter for attenuating frequencies above and below the modulation frequency of the UV radiation. By using such filters, for example, in the form of a high-pass filter and a low-pass filter and/or a bandpass filter, it is easily possible to attenuate interfering influences of other frequencies, in particular overtones of the signal to be analysed in such a manner that they no longer significantly influence the measurement result.

A particular advantage of the apparatus according to the invention furthermore consists in that an extremely rapid detection of fluorescent regions on surfaces is possible. Only a few 1/100 seconds is required for this if the electronics is suitably designed. This makes the apparatus suitable, for example, for the detection of fluorescent markings on object surfaces, for example, on tickets, banknotes, stamps or security labels or tags which move very rapidly past the apparatus such as, for example, banknotes in cash machines or money counting machines or stamps in letter centers.

### BRIEF DESCRIPTION OF THE DRAWINGS

The explanation is explained in detail hereinafter with reference to drawings showing an exemplary embodiment. In the figures:

FIG. 1 shows an apparatus for determining the tin contamination on a surface of a glass product in a first configuration in schematic side view,

FIG. 2 shows an apparatus for determining the tin contamination on a surface in a second configuration in schematic side view,

FIG. 3 shows an apparatus for determining the tin contamination on a surface in a third configuration in schematic side view,

FIG. 4 shows an apparatus for determining the tin contamination on a surface in a fourth configuration in schematic side view, with means for online monitoring of the UV beam power,

FIG. 5 shows an apparatus for determining the tin contamination on a surface in a fifth configuration in schematic side view, with a beam splitter and means for online monitoring of the UV beam power,

FIG. 6 shows the apparatus of FIG. 3 with an electronic triggering and evaluation unit,

FIG. 7 shows an apparatus for determining the tin contamination on a surface in an alternative configuration,

FIG. 8 shows a block diagram of the evaluation electronics downstream of the detector unit and

FIG. 9 shows a typical fluorescence spectrum of the tin bath side of float glass.

### DETAILED DESCRIPTION

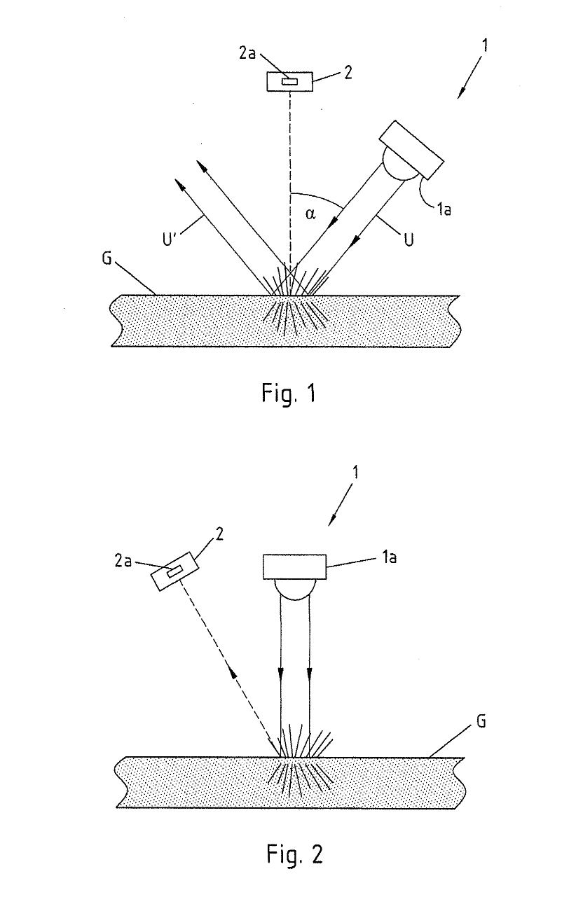

FIG. 1 shows an apparatus for determining the element occupancy on a surface by means of fluorescence. In particular, this comprises an apparatus for determining the tin contamination on a surface G of a glass product, in the present case on a float glass pane. The apparatus comprises a beam source 1 for generating UV radiation which excites tin atoms on the glass surface G to fluorescence. According to the invention, the beam source 1 comprises a light-emitting diode 1a (LED) emitting UV radiation U as a beam-producing element. This preferably comprises a diode which emits in the UV C range, preferably at about 280 nm in order to maximize the quantum yield in the tin fluorescence.

The apparatus further comprises a detector unit 2 for detecting the fluorescence radiation F emitted isotropically by the tin atoms present on the glass surface G. The detector unit 2 for its part comprises a detector element, in the present case a photodiode 2a, in which the incident beam power is converted into a proportional current. As can be seen in FIG. 1, the beam source 1 and the detector unit 2 are aligned relative to one another and to the glass surface G in such a manner that the incident UV light U is incident on the glass surface G at an angle α>0 and is reflected at the surface G by the same angle. The detector on the other hand is substantially perpendicular to the glass surface so that the detector element 2a is not acted upon by reflected UV radiation U′ but exclusively by fluorescence radiation F. In this case, it is advantageously taken into account that the intensity of the fluorescence radiation usually has an intensity maximum in the perpendicular direction relative to the surface so that a signal having comparatively high intensity is measured in the detector unit. Not shown in FIG. 1, as in all the other figures, is a protective glass made of quartz glass which protects the detector unit from contaminants.

FIG. 2 shows another apparatus for determining the tin contamination on a surface in an alternative configuration to the apparatus from FIG. 1. Unlike the apparatus in FIG. 1, the beam source 1 here is aligned with the UV light-emitting diode 1a perpendicular to the surface so that said diode irradiates this surface at a vanishing angle of incidence (α=0). The detector unit 2 is configured in such a manner that the detector element 2 only detects the fluorescence radiation emitted at an angle to the surface, as shown in FIG. 2. In this configuration, the UV radiation of the light-emitting diode 1a is thus back-reflected into this and cannot be incident on the detector element 2a.

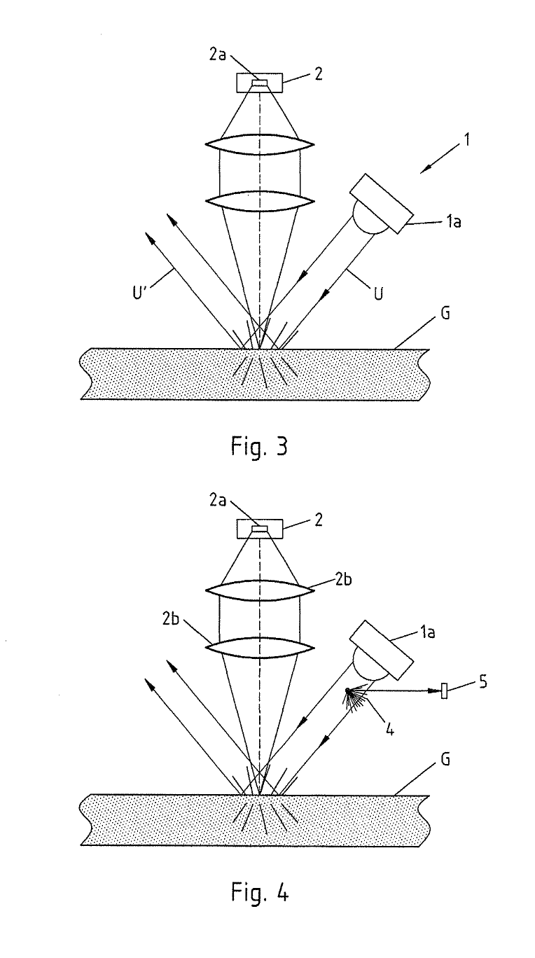

FIG. 3 shows another apparatus for determining the tin contamination on a surface. This substantially corresponds to that of FIG. 1, wherein the apparatus in the present case comprises two biconvex focussing lenses for focussing the fluorescence signal onto the detector element 2a. The use of focussing optics has the advantage that the distance sensitivity of the apparatus described previously in connection with FIGS. 1 and 2 is severely reduced. Studies made by the applicant have shown that by using focussing optics, the distance sensitivity of the fluorescence signal at the detector element can be reduced by a factor of 5. Finally, by using focussing optics, it is possible to work with a significantly increased object distance (distance between the surface to be studied and the focussing lens facing this surface).

The apparatus shown in FIG. 4 differs from that shown in FIG. 3 in that means for online monitoring of the UV beam power are provided. In the apparatus in FIG. 4, these are configured as a scattering and/or fluorescent surface 4 disposed in the beam path of the UV-LED 1a. In the present case, this comprises a polyamide or polyester fiber coated with a fluorescent dye or a Polyneon® material 4 whose surface fluoresces when irradiated with UV light. This additional fluorescence signal can be recorded by means of a further detector unit 5. The electrical signal produced in this detector unit 5 can be processed with the detector signal of the first detector unit 2 in common evaluation electronics (not shown in FIG. 4) so that fluctuations in the intensity of the fluorescence radiation which are unambiguously attributable to a fluctuation of the exciting UV beam power are identified as such and can be compensated.

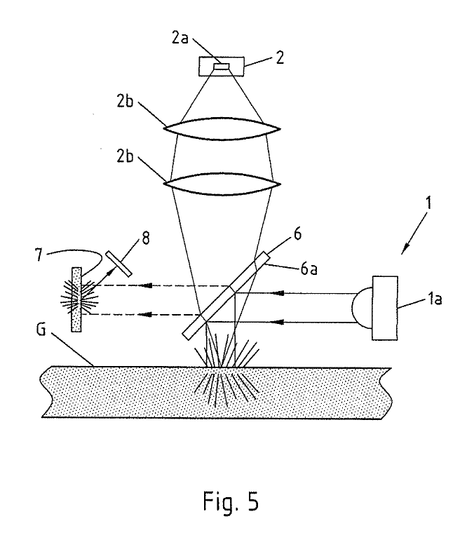

FIG. 5 shows another apparatus for determining the tin contamination on a surface. This apparatus comprises a quartz glass beam splitter 6 which is provided with a wavelength-sensitive coating 6a. This is constituted in such a manner that most (>80%) of the incident UV radiation is reflected in the direction of the surface G whilst a small portion (<20%) is transmitted. This fraction is incident on a fluorescent surface 7, wherein the fluorescence light generated here is recorded by another detector unit 8. By this means, online power monitoring is again achieved. Furthermore, the detector unit 2 and the detector unit 8 are connected to a common evaluation electronics (not shown) so that power fluctuations of the beam source 1 can be compensated.

The reflected UV radiation is incident on the surface G and there induces fluorescence radiation in the manner already explained. However, the beam splitter 6 is largely transparent for the fluorescence light so that the fluorescence intensity passes through the beam splitter 6 without appreciable attenuation and is focussed onto the detector element 2a by means of the focussing optics already described in connection with FIG. 3. The back-reflected UV radiation from the surface G passes through the beam splitter only severely attenuated and is completely absorbed in the focussing lenses 2b so that the fluorescence signal has no influence in the detector element 2a.

If the angular position of the beam splitter 6 is varied (not shown), it can be achieved that the back-reflected radiation is no longer incident on the beam splitter. In this case, the UV-absorbing focussing optics 2b can also be dispensed with.

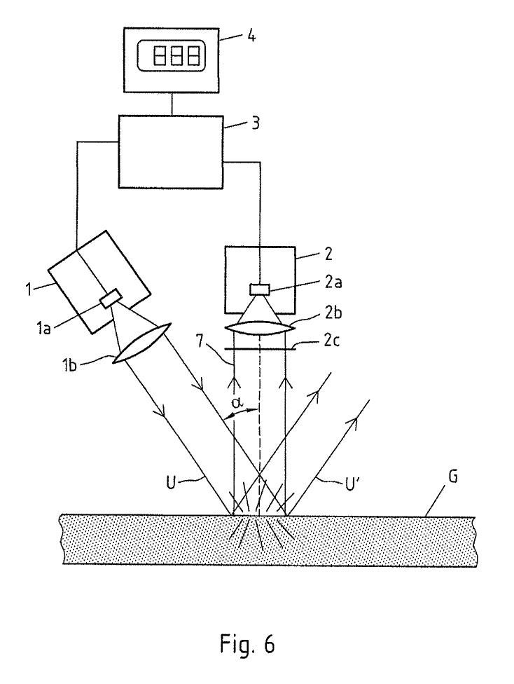

The apparatus shown in FIG. 6 is substantially the same as that in FIG. 3. In this exemplary embodiment, the exciting UV radiation emitted by the UV-LED is incident on the surface G at an angle α>0, the induced fluorescence radiation being detected by a detector unit 2 disposed perpendicularly to the glass surface G. As a result of this relative alignment of beam source 1 and detector unit 2, any exposure of the detector element 2a to back-reflected UV radiation is reliably avoided. In order to collimate the emitted UV radiation, the beam source 1 comprises a collimating lens 1b which produces an approximately parallel beam profile so that a uniform excitation intensity is present on the glass surface G to be studied regardless of the respectively selected distance.

The detector unit 2 in turn comprises a photodiode 2a as a detector element on which the fluorescence radiation F is focussed by means of a focussing lens 2b. An optical filter 2c for filtering out ambient light in order to further minimise interfering influences is located in front of the focussing lens 2b in the direction of propagation of the fluorescence radiation F.

The apparatus according to FIG. 6 further comprises a combined triggering and evaluation unit 3 which contains the triggering electronics (not shown in detail) for the UV-LED 1a. The triggering electronics comprises an oscillator which modulates the emitted UV light U at a frequency of 1.5 kHz in the present case. The triggering and evaluation unit 3 further contains a circuit which converts the current signal generated by the photodiode 2a as a function of the intensity of the emitted fluorescence radiation F into a proportional direct voltage which for its part is output as a numerical value on display means in the form of a display unit 4. Alternatively or additionally to the display unit 4 shown in FIG. 6, colored display LEDs can also be provided which signal whether the tin bath side (e.g. green LED lights up) or the side facing away from the tin bath (e.g. red LED lights up) was studied. Input means (not shown) can furthermore be provided on the triggering and evaluation unit 3 by which means a first and a second threshold value can be set in order, for example, to take into account the material composition of the type of glass being studied in each case, which for its part influences the intensity of the fluorescence signal.

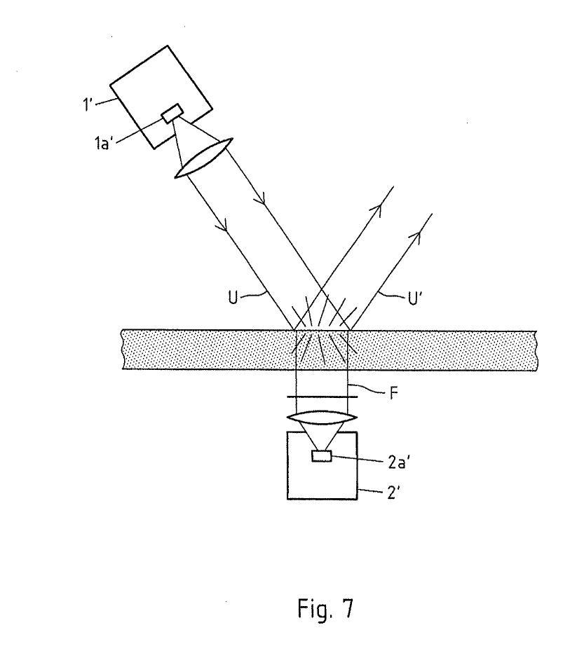

FIG. 7 shows an alternative configuration of beam source 1′ and detector unit 2′. In this case, the beam source 1′ is located unchanged above the glass surface G to be studied and irradiates this again at an angle of incidence of about 35°. The detector unit 2′ on the other hand is located below the float glass and receives the fluorescence radiation F′ generated at the surface facing the beam source 1′ and transmitted by the glass body. The advantage in this case is that no interfering excitation radiation U′ can be incident on the detector element 1a′ since this is completely absorbed in the glass.

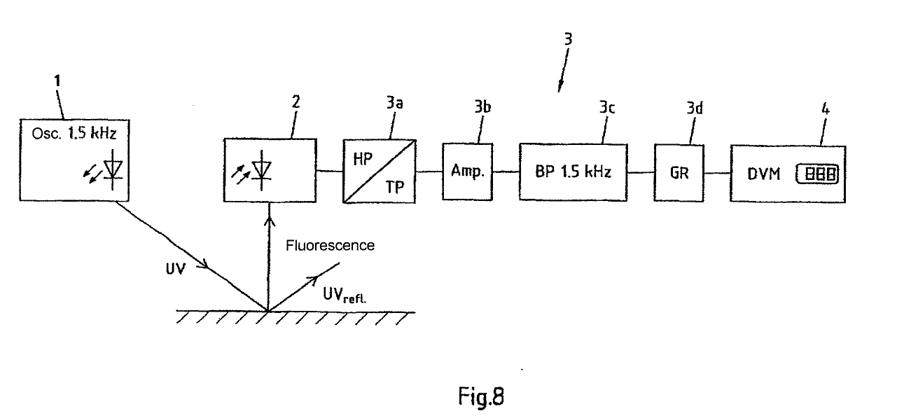

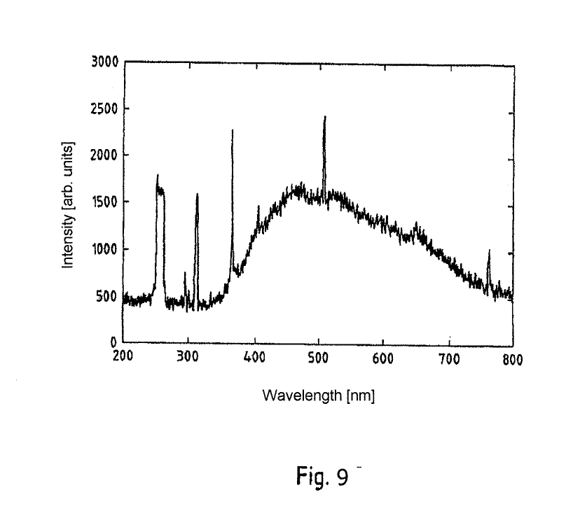

FIG. 8 now shows a block diagram of the evaluation electronics downstream of the detector unit 2. As has already been mentioned, the UV radiation generated by the UV-LED used according to the invention is modulated by means of an oscillator at a frequency of 1.5 kHz. The fluorescence light generated on the glass surface G is converted by the photodiode 2a present as a detector element in the detector unit 2 into a current signal which is relayed to the evaluation unit 3. There it passes as a voltage signal tapped at an Ohmic resistance through a plurality of high-pass and low-pass filters which are symbolized in summary by block 3a. Furthermore, the signal is amplified in a plurality of amplifier stages combined in the block 3b. The signal passes further through a bandpass filter 3c having a center frequency of 1.5 kHz, that is the modulation frequency of the excitation signal U and the fluorescence signal F. Finally the 1.5 kHz voltage signal is rectified in a rectifier and output to the display unit (DVM).

If, as described in connection with FIG. 4 or 5, online power monitoring by means of a beam splitter or fluorescent surface is inserted in the beam path of the UV-LED 1a, the fluorescence radiation generated on the fluorescent surface 4, 7 is passed to a second detector unit 5, 8 and detected there. This detector unit 5, 8 can then be followed by an evaluation unit (not shown) identical to the evaluation unit 3 described in detail in FIG. 8 whose output signal can then likewise be output to the DVM.

The apparatus according to the invention provides a compact and independently operable measuring device as a result of the low power consumption of the UV-LED used according to the invention which makes it possible to achieve reliable and reproducible results when determining the element occupancy on a surface. The use for determining tin contamination on float glass proves to be particularly advantageous.

1. Apparatus for determining an element occupancy on a surface,
comprising a UV beam source for generating a beam comprising at least one UV light-emitting diode whose UV radiation excites the element to fluorescence and
comprising a detector unit for the detection of fluorescence radiation,
wherein beam guidance is configured by alignment of the UV beam source and the detector unit relative to the surface and/or by using a wavelength-selective beam splitter in a beam path in such a manner that UV radiation back-reflected from the surface is kept away from the detector unit.

2. The apparatus according to claim 1, wherein the UV beam source and the detector unit are aligned relative to the surface in such a manner that the detector unit is disposed outside the reflected beam.

3. The apparatus according to claim 2, wherein the at least one UV light-emitting diode irradiates the surface at an angle of incidence α>0 and the detector unit is aligned substantially perpendicularly to the surface.

4. The apparatus according to claim 2, wherein the at least one UV light-emitting diode irradiates the surface at a vanishing angle of incidence (α=0) and the detector unit is aligned in such a manner that it detects the fluorescence radiation emitted at an angle to the surface.

5. The apparatus according to claim 1, wherein the light-emitting diode emits in the UV C range.

6. The apparatus according to claim 1, wherein the beam source has at least one first beam-forming element wherein the at least one first beam-forming element collimates the beam.

7. The apparatus according to claim 6, wherein the detector unit comprises a detector element, for converting fluorescence radiation into an electrical signal and at least one second beam-forming element for focussing the fluorescence radiation onto the detector element and/or a filter element for filtering out interfering light.

8. The apparatus according to claim 1, wherein the apparatus further comprises means for online monitoring of the UV beam power of the at least one UV light-emitting diode.

9. The apparatus according to claim 8, wherein the means for online monitoring of the UV beam power comprise a second fluorescent surface and second detector unit, wherein the second detector unit detects the fluorescence radiation emitted by the second surface.

10. The apparatus according to claim 8, wherein the wavelength-selective beam splitter reflects the UV radiation onto the surface and transmits a small fraction of beam intensity to the means for online monitoring of the UV beam power.

11. The apparatus according to claim 10, wherein the means for online monitoring of the UV beam power comprises a scattering and/or fluorescent surface disposed in the beam path of the UV radiation.

12. The apparatus according to claim 11, wherein the scattering and/or fluorescent surface is configured as a thread disposed in the beam path of the UV radiation.

13. The apparatus according to claim 1, wherein the beam source comprises modulation means for modulating the UV radiation emitted by the light-emitting diode.

14. The apparatus according to claim 1, wherein the apparatus further comprises electronic evaluation means (3) for producing an electrical signal value characterizing fluorescence intensity.

15. The apparatus according to claim 14, wherein a first threshold value can be set in the electronic evaluation means depending on a condition of the surface to be studied, below which threshold value the electrical signal value represents a surface not occupied by elements.

16. The apparatus according to claim 15, wherein a second threshold value can be set in the electronic evaluation means depending on the condition of the surface to be studied, above which threshold value the electrical signal value represents a surface occupied by elements.

17. An installation for the production and/or processing of glass products, comprising an apparatus according to claim 1.

18. (canceled)

19. (canceled)

20. The apparatus according to claim 1, wherein the apparatus determines tin contamination on float glass.

21. The apparatus according to claim 5, wherein the light-emitting diode emits at about 280 nm or below.

22. The apparatus according to claim 1, wherein the detector unit comprises a detector element for converting fluorescence radiation into an electrical signal and at least one beam-forming element for focussing the fluorescence radiation onto the detector element and/or a filter element for filtering out interfering light.

23. The apparatus according to claim 14, wherein a threshold value can be set in the electronic evaluation means depending on a condition of the surface to be studied, above which threshold value the electrical signal value represents a surface occupied by elements.
